(19) United States
(12) Patent Application Publication
(10) Pub. No.: US 2007/0116054 A1
(43) Pub. Date: May 24, 2007

(54) Image transmission apparatus

(75) Inventor: Kazuya Hamaguchi, Nara (JP)

Correspondence Address: EDWARDS & ANGELL, LLP, P.O. BOX 55874, BOSTON, MA, 02205, US

(73) Assignee: Sharp Kabushiki Kaisha, Osaka (JP)

(21) Appl. No.: 11/546,204

(22) Filed: Oct. 10, 2006

(30) Foreign Application Priority Data
Oct. 20, 2005 (JP) 2005-306195

(51) Int. Cl. H04J 3/24

(52) U.S. Cl. 370/475

(57) ABSTRACT

In an image transmission apparatus that transmits image data to the transmission destination accepted by the operation panel, an external storage I/F (connector) to which a USB memory (external storage medium) storing transmission destination information is connected is provided, the transmission destination information is read from the USB memory connected to the external storage I/F, and the transmission destination is accepted based on the transmission destination information being read. The security of the private information included in the transmission destination information used for specifying the transmission destination is enhanced.

### CROSS-REFERENCE TO RELATED APPLICATIONS

This Nonprovisional application claims priority under 35 U.S.C. §119(a) on Patent Application No.2005-306195 filed in Japan on Oct. 20, 2005, the entire contents of which are hereby incorporated by reference.

### BACKGROUND OF THE INVENTION

The present invention relates to an image transmission apparatus that transmits image data to a transmission destination accepted by a transmission destination acceptor.

When fax transmission is performed by using an image transmission apparatus having a facsimile function or when image transmission such as scan to fax, scan to e-mail or scan to FTP (an image read by a scanner is transmitted by fax, by e-mail or via FTP) is performed by using an image transmission apparatus having an electronic mail or Internet fax function, it is necessary to specify the transmission destination, and the transmission destination address is inputted, for example, from an operation panel.

FIGS. 1A and 1B are views showing examples of setting screens for a conventional image transmission. FIG. 1A shows an example of the setting screen for Internet fax, and FIG. 1B shows an example of the setting screen for electronic mail (e-mail) or FTP. FIG. 2A is a view showing an example of an address input screen. These screens are displayed on a touch-panel display screen of the operation panel, and accept operation inputs of the keys on the screens. When an address input key K22 is selected on the setting screen shown in FIG. 1A or 1B, the address input screen shown in FIG. 2A is displayed on the display screen. On the address input screen, alphabetic keys K34 are displayed, and input of alphabets such as e-mail address is accepted. Input of numerals may be accepted from a numeric keypad similarly to facsimile number and the like, or the input mode may be switched from an alphabet input mode to a numeral input mode within the address input screen.

However, when the transmission destination address is inputted every transmission, not only the input is a burden on the user but also there is a possibility of an input error. Therefore, it is also performed to prestore transmission destination addresses in the apparatus and selects a transmission destination from among a list of transmission destination addresses stored in the apparatus (see, for example, Japanese Patent Application Laid-Open No 05-227399(1993)).

FIG. 2B is a view showing an example of the transmission destination selection screen. When an address book key K20 is selected on the setting screen shown in FIG. 1A or 1B, the transmission destination selection screen shown in FIG. 2B is displayed on the display screen. On the transmission destination selection screen, the pregistered transmission destinations such as e-mail addresses are listed, and the selection of the transmission destination is accepted.

### BRIEF SUMMARY OF THE INVENTION

However, the transmission destination addresses include private information such as addresses, fax numbers and e-mail addresses from which individuals can be identified, and the private information stored in apparatuses can be easily perused by operating the apparatuses.

The present invention is made in view of such circumstances, and an object thereof is to provide an image transmission apparatus in which by providing a connector to which an external storage medium storing transmission destination information is connected; and a reader that reads the transmission destination information from the external storage medium connected to the connector, and accepting the transmission destination based on the transmission destination information read by the reader, the security of the private information included in the transmission destination information can be enhanced.

Moreover, another object of the present invention is to provide an image transmission apparatus in which by providing an authentication acceptor that accepts authentication information; and an authenticator that performs authentication based on the authentication information accepted by the authentication acceptor, and reading the transmission destination information from the external storage medium when the authentication by the authenticator is successful, the security of the private information included in the transmission destination information stored in the external storage medium can be enhanced.

Moreover, yet another object of the present invention is to provide an image transmission apparatus in which by the transmission destination information including the facsimile number, the electronic mail address, or the address of the FTP server, the security of the private information such as the facsimile number, the electronic mail address or the address of the FTP server can be enhanced.

Moreover, still another object of the present invention is an image transmission apparatus in which by storing, when the transmission destination is accepted based on the transmission destination information read from the external storage medium, historical information of a transmission performed to the accepted transmission destination into the external storage medium, the security of the private information included in the transmission history can be enhanced.

An image transmission apparatus according to the present invention that transmits image data to a transmission destination accepted by transmission destination accepting means is provided with: a connector to which an external storage medium storing transmission destination information is connected; and reading means for reading the transmission destination information from the external storage medium connected to the connector, and the transmission destination accepting means accepts the transmission destination based on the transmission destination information read by the reading means.

In the present invention, since the transmission destination information is read from the external storage medium connected to the connector and the transmission destination is accepted based on the transmission destination information being read, transmission destination information including private information such as addresses, facsimile numbers and e-mail addresses from which individuals can be identified can be stored and managed outside the apparatus. Since it is unnecessary to store the transmission destination information inside the apparatus, the security of the private information included in the transmission destination information used for specifying the transmission destination can be enhanced.

An image transmission apparatus according to the present invention is provided with: authentication accepting means for accepting authentication information; and authenticating means for performing authentication based on the authentication information accepted by the authentication accepting means, and the reading means reads the transmission destination information from the external storage medium when the authentication by the authenticating means is successful. In the present invention, since authentication is performed based on the authentication information accepted by the authentication accepting means and the transmission destination information is read from the external storage medium when authentication is successful, access to the external storage medium can be restricted. By restricting access to the external storage medium, the security of the private information included in the transmission destination information stored in the external storage medium can be enhanced.

In an image transmission apparatus according to the present invention, the transmission destination information includes a facsimile number, an electronic mail address, or an address of an FTP server. In the present invention, since the transmission destination information includes the facsimile number, the electronic mail address, or the address of the FTP server, the security of the private information related to the transmission destination such as the facsimile number, the electronic mail address or the address of the FTP server can be enhanced.

An image transmission apparatus according to the present invention is provided with storing means for storing, when the transmission destination is accepted based on the transmission destination information read from the external storage medium, historical information of a transmission performed to the accepted transmission destination into the external storage medium. In the present invention, since when the transmission destination is accepted based on the transmission destination information read from the external storage medium, the historical information of the transmission performed to the accepted transmission destination is stored into the external storage medium, the transmission history including private information such as addresses, facsimile numbers and e-mail addresses from which individuals can be identified can be stored and managed outside the apparatus. Since it is unnecessary to store the transmission history in the apparatus, the security of the private information included in the transmission history can be enhanced.

The above and further objects and features of the invention will more fully be apparent from the following detailed description with accompanying drawings.

### BRIEF DESCRIPTION OF THE SEVERAL VIEWS OF THE DRAWINGS

FIGS. 1A and 1B are views showing the examples of the setting screens for the conventional image transmission;

FIG. 2A is a view showing the example of the address input screen;

FIG. 2B is a view showing the transmission destination selection screen;

FIG. 3 is a block diagram showing an example of a multifunction device (image transmission apparatus) according to the present invention;

FIG. 4 is a block diagram showing a structure example of a USB memory;

FIG. 5 is a schematic view showing an example of an operation panel;

FIGS. 6A and 6B are views showing examples of the setting screens of the image transmission;

FIG. 7A is a view showing an example of an authentication screen;

FIG. 7B is a view showing an example of an address capture screen;

FIGS. 8A and 8B are views showing examples of transmission histories; and

FIGS. 9A and 9B are a flowchart showing an example of the processing procedure of the image transmission.

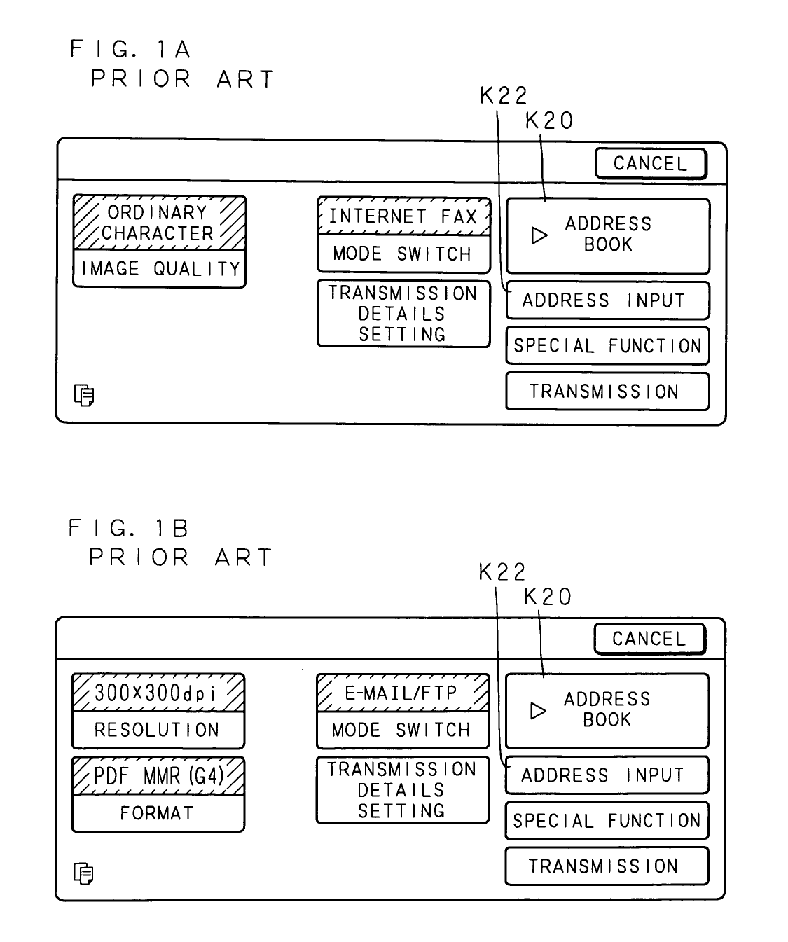

### DETAILED DESCRIPTION OF THE INVENTION

Hereinafter, the present invention will be concretely described based on the drawings showing an embodiment thereof. The present embodiment will be described with a multifunction device having a facsimile function and an electronic mail function as an example.

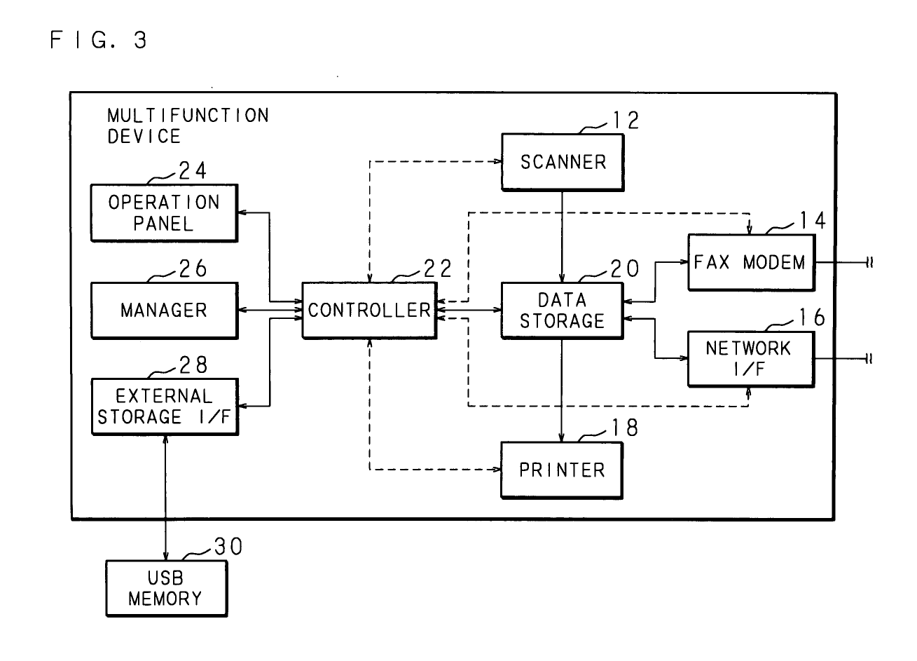

FIG. 3 is a block diagram showing an example of the multifunction device (image transmission apparatus) according to the present invention. The multifunction device is provided with: an image scanner (hereinafter, abbreviated as scanner) 12 that reads an image of the original; a fax (facsimile) modem 14 that performs facsimile transmission and reception; a network I/F (interface) 16 that performs electronic mail transmission and reception, FTP transfer, and the like; a printer 18 that forms an image corresponding to image data on a sheet; a data storage 20 such as a hard disk that stores image data and the like; a touch-panel operation panel (transmission destination acceptor, authentication acceptor) 24 having a liquid crystal display and operation keys such as a numeric keypad; an external storage I/F (USB I/F (connector)) 28 to which an external storage medium such as a USB (universal serial bus) memory 30 is connected; a manager 26 such as a flash memory; and a controller 22 such as a CPU that controls the scanner 12; the fax modem 14, the network I/F 16, a printer 18, the data storage 20, the operation panel 24, the manager 26 and the external storage I/F 28.

The data storage 20 stores the image data read by the scanner 12, the image data transmitted or received by the fax modem 14, the image data transmitted or received by the network I/F 16, the image data to be printed by the printer 18, and the like. Although not shown, the controller 22 has a ROM storing control programs and the like and a RAM storing temporary data. The manager 26 stores various pieces of setting information, transmission destination addresses, historical information (fax transmission history, fax reception history, print history, etc.).

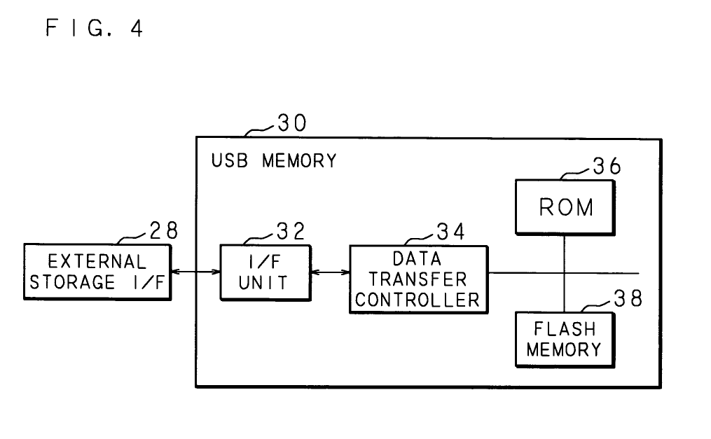

FIG. 4 is a block diagram showing a structure example of the USB memory 30. The USB memory 30 is provided with: an I/F unit 32 connected to the external storage I/F 28 of the multifunction device; a flash memory 38 storing transmission destination addresses and the like; and a data transfer controller 34 such as a CPU that controls data reading from the flash memory 38 to the I/F unit 32 and data writing from the I/F unit 32 to the flash memory 38 based on the control program stored in a ROM 36. The data transfer controller 34 performs authentication processing with the controller 22 of the multifunction device, and when authentication is successful, permits the data transfer with the multifunction device (external storage I/F 28).

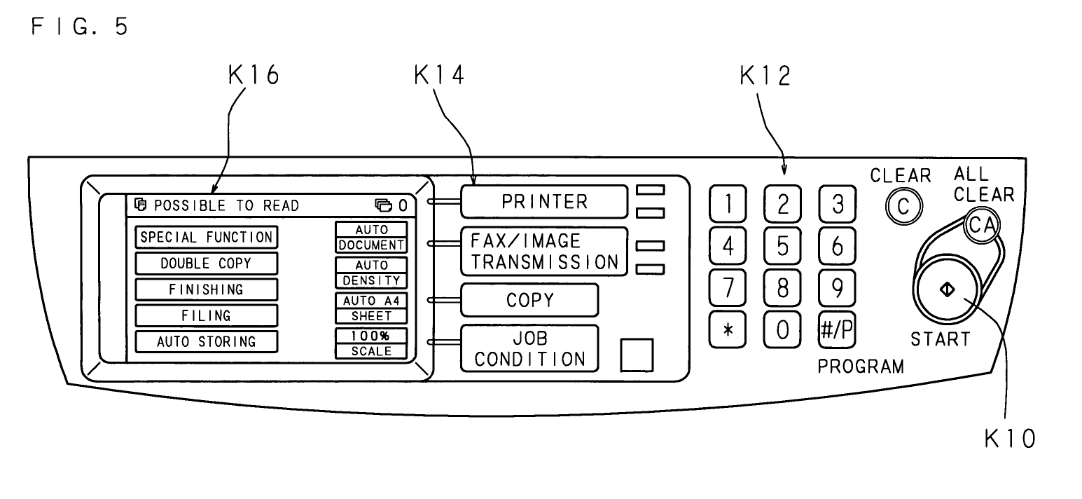

FIG. 5 is a schematic view showing an example of the operation panel 24. The operation panel 24 is provided with a start key K10, a numeric keypad K12, a mode (a printer mode, a fax/image transmission mode, a copy mode) switching key K14, and a touch-panel liquid crystal display K16.

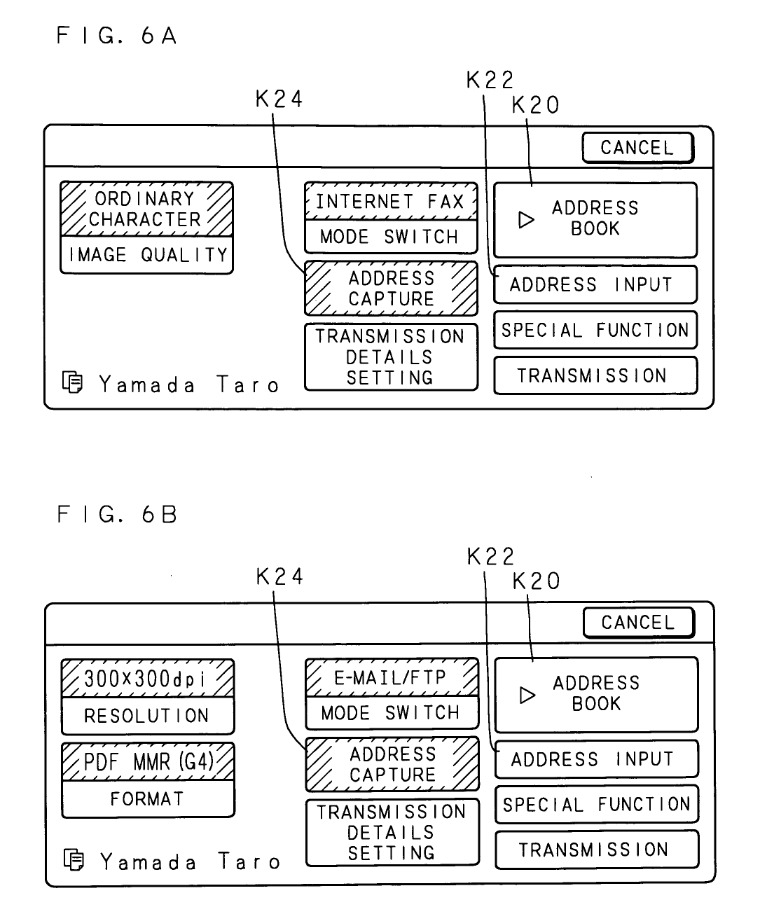

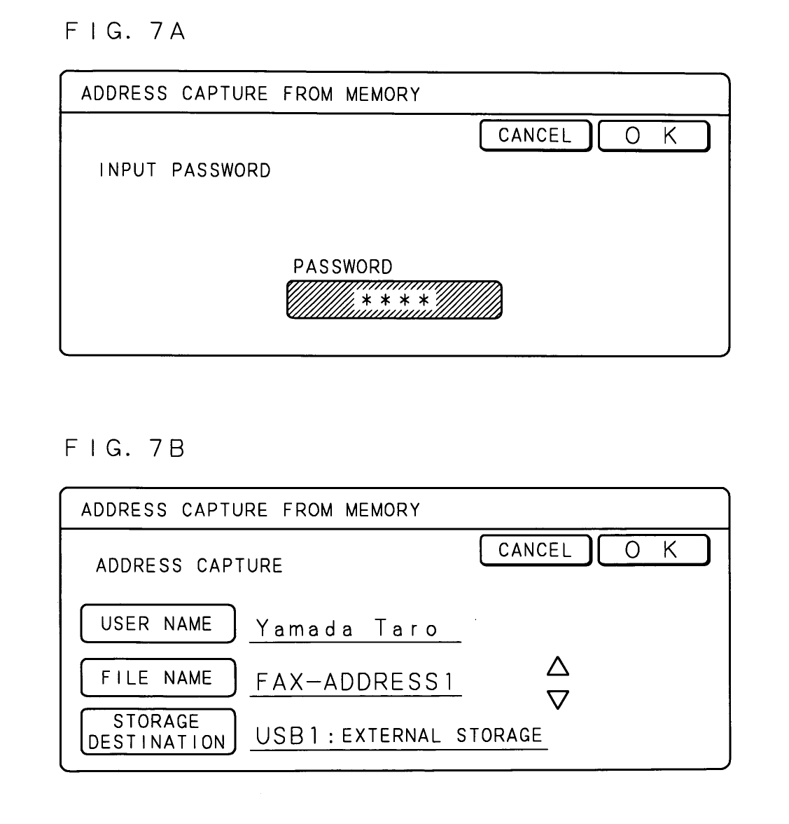

FIGS. 6A and 6B are views showing examples of the setting screens of the image transmission. FIG. 6A shows an example of the setting screen for the Internet fax, and FIG. 6B shows an example of the setting screen for electronic mail (e-mail) or FTP. FIG. 7A is a view showing an example of an authentication screen, and FIG. 7B is a view showing an example of an address capture screen. These screens are displayed on the liquid crystal display K16 by the control by the controller 22, and accept operation inputs of the keys on the screens. When an address capture key K24 is selected under a condition where the setting screen shown in FIG. 6A or 6B is displayed on the liquid crystal display K16 in response to an operation of the mode switching key K14, the authentication screen shown in FIG. 7A is displayed on the liquid crystal display K16 by the control by the controller 22.

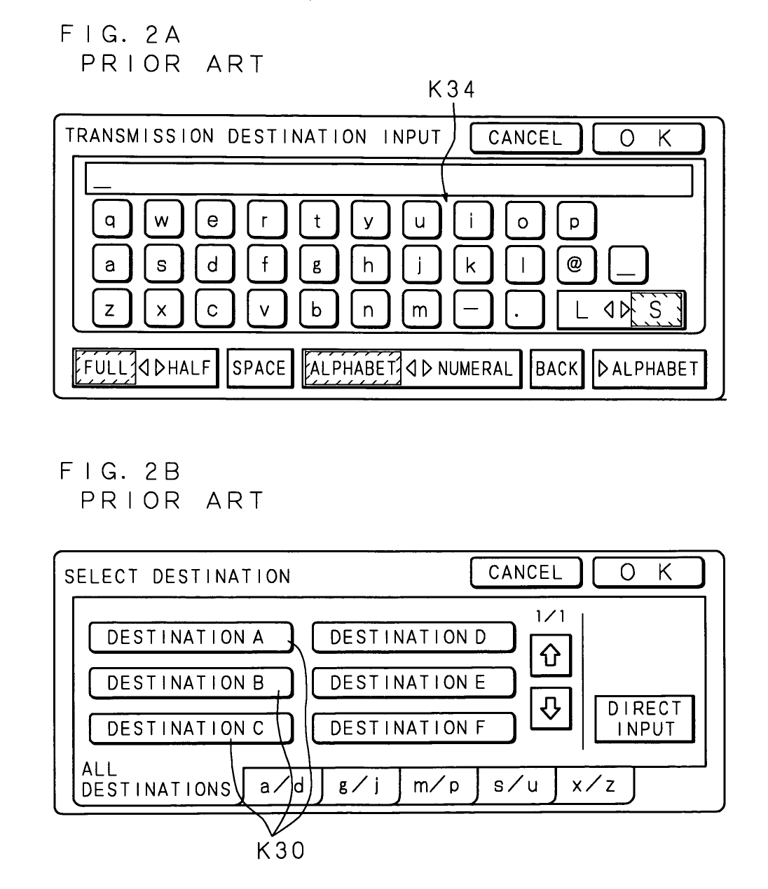

When a password is accepted from the numeric keypad K12, the controller (authenticator) 22 performs authentication processing with the data transfer controller 34 of the USB memory 30 through the external storage I/F 28, and when authentication is successful, access to the USB memory 30 is enabled. When authentication is successful, the controller (reader) 22 obtains the data information in the USB memory 30 from the data transfer controller 34 of the USB memory 30 through the external storage I/F 28, and displays the obtained data information (the user name, the file name, the storage destination) on the liquid crystal display K16 as shown in FIG. 7B. When an OK key is selected, the controller 22 obtains the address data (the file name: FAX-ADDRESS1 in the example of FIG. 7B) in the USB memory 30 from the data transfer controller 34 of the USB memory 30 through the external storage I/F 28, stores it in the RAM, and lists the transmission destinations corresponding to the obtained address data on the liquid crystal display K16 (see FIG. 2B). When a plurality of pieces of address data are stored in the USB memory 30, the selection of the address data to be used is accepted by the operation panel 24, and the selected address data is obtained.

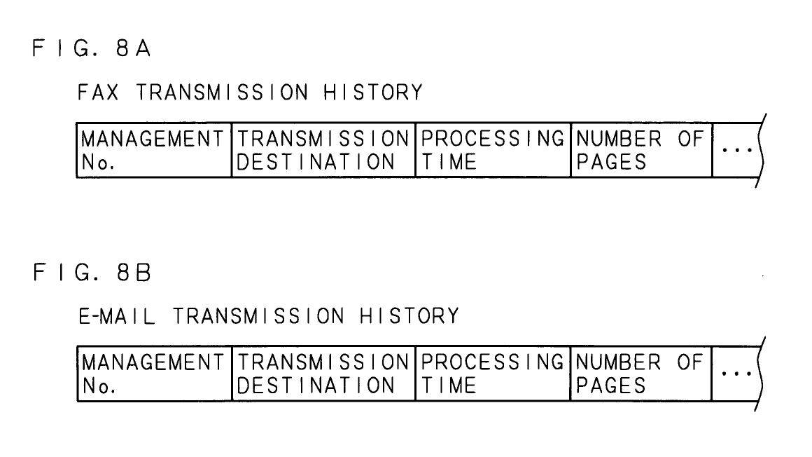

When transmission using the address data obtained from the USB memory 30 is performed, the controller (storage) 22 stores the transmission history related to the performed transmission from the data transfer controller 34 of the USB memory 30 into the flash memory 38 through the external storage I/F 28. FIGS. 8A and 8B are views showing examples of the transmission histories. FIG. 8A is a view showing an example of the fax transmission history, and FIG. 8B is a view showing an example of the e-mail transmission history. The transmission history includes information such as the management No., the transmission destination (the fax number or the e-mail address), the processing time of day, and the number of pages. When the transmission destination address stored in the manager 26 is used or when the transmission destination address is directly inputted from the operation panel 24, the transmission history is stored into the manager 26 by the controller 22. It is to be noted that it may be performed to store all the transmission histories in the USB memory 30.

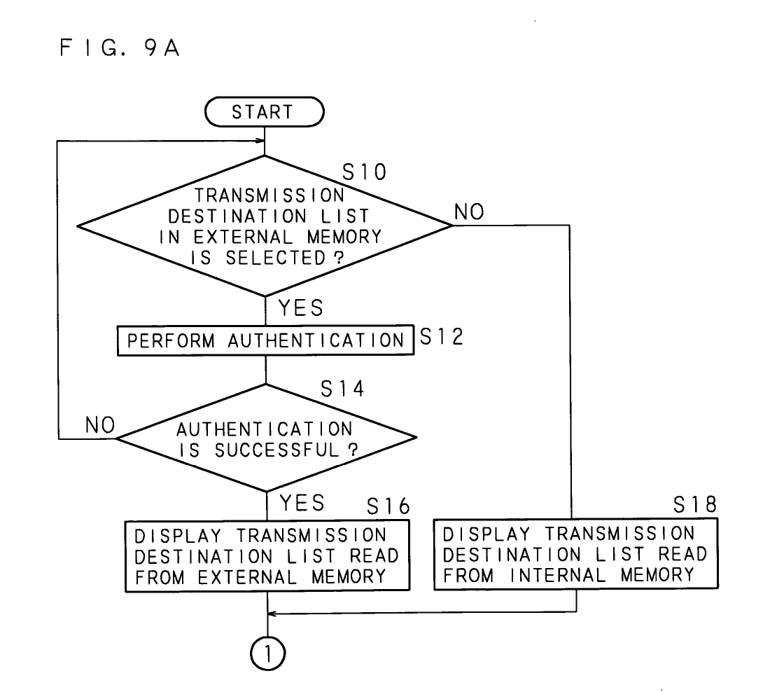

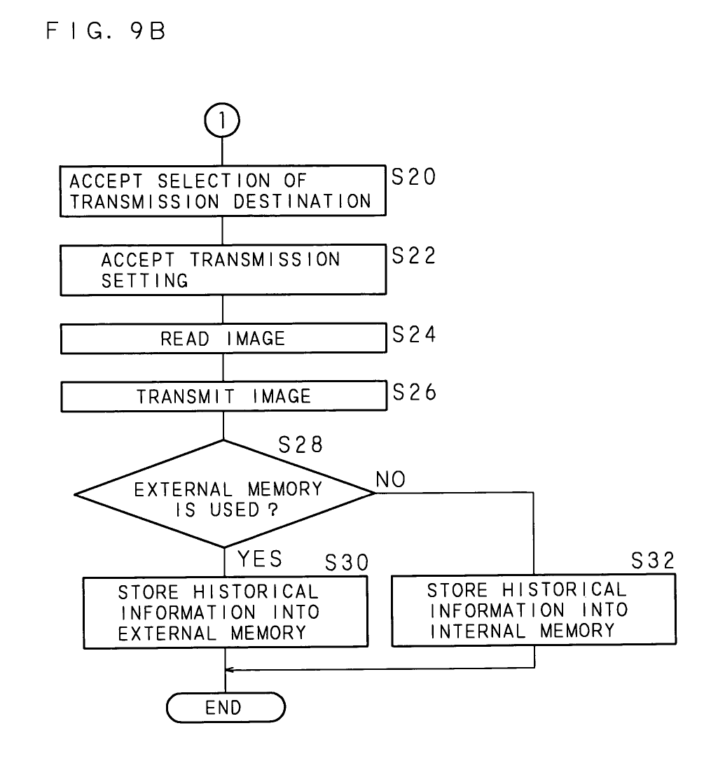

FIGS. 9A and 9B are a flowchart showing an example of the processing procedure of the image transmission by facsimile, by electronic mail or via FTP. In response to an operation of the mode switching key K14, the controller 22 displays the setting screen shown in FIG. 6A or 6B on the liquid crystal display K16 of the operation panel 24. When the transmission destination list (list of transmission destination addresses) stored in an internal memory (manager 26) such as the address book key K20 is selected (S10: NO), the transmission destination list read from the internal memory such as the manager 26 is listed on the liquid crystal display K16 by the control by the controller 22 (S18) (see FIG. 2B).

When a transmission destination address stored in the external memory (USB memory 30) such as the address capture key K24 is selected (S10: YES), the authentication screen shown in FIG. 7A is displayed on the liquid crystal display K16 by the control by the controller 22, and authentication by a password is performed (S12). When a password is accepted from the numeric keypad K12, the controller 22 performs authentication processing with the data transfer controller 34 of the USB memory 30 through the external storage I/F 28, and when authentication is successful, access to the USB memory 30 is enabled. When authentication is successful (S14: YES), the controller 22 reads the transmission destination list from the external memory such as the USB memory 30 through the external storage I/F 28, and lists it on the liquid crystal display K16 (S16) (see FIG. 2B).

When the selection of the transmission destination and the transmission setting are accepted (S20, S22) and the start key K10 is depressed, the controller 22 controls the scanner 12 to perform image reading (S24), stores the image data being read into the data storage 20, and successively transmits it from the fax modem 14 or the network I/F 16 (S26). The transmission destination may be directly inputted from the operation panel 24. When the external memory is used after the transmission (S28: YES), the controller 22 stores the historical information into the USB memory (external memory) 30, and when the external memory is not used (S28: NO), the controller 22 stores the historical information into the manager (internal memory) 26 (S32).

While the USB memory is used as an example of the external memory (external storage medium) in the above-described embodiment, the external memory is not limited to the USB memory, and any external storage medium that can be detachably attached to the multifunction device may be used. While a multifunction device is described as an example in the above-described embodiment, the present invention may be applied to any transmission apparatus in which transmission destination addresses can be registered (stored) such as a facsimile device.

As this invention may be embodied in several forms without departing from the spirit of essential characteristics thereof, the present embodiment is therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

What is claimed is:

1. An image transmission apparatus that transmits image data to a transmission destination accepted by a transmission destination acceptor, the apparatus comprising:
a connector to which an external storage medium storing transmission destination information is connected; and
a reader that reads the transmission destination information from the external storage medium connected to the connector,
wherein the transmission destination acceptor accepts the transmission destination based on the transmission destination information read by the reader.

2. The image transmission apparatus according to claim 1, further comprising:
an authentication acceptor that accepts authentication information; and
an authenticator that performs authentication based on the authentication information accepted by the authentication acceptor,
wherein the reader reads the transmission destination information from the external storage medium when the authentication by the authenticator is successful.

3. The image transmission apparatus according to claim 2, wherein the transmission destination information includes a facsimile number, an electronic mail address, or an address of an FTP server.

4. The image transmission apparatus according to claim 3, further comprising a storage that stores, when the transmission destination is accepted based on the transmission destination information read from the external storage medium, historical information of a transmission performed to the accepted transmission destination into the external storage medium.

5. The image transmission apparatus according to claim 2, further comprising a storage that stores, when the transmission destination is accepted based on the transmission destination information read from the external storage medium, historical information of a transmission performed to the accepted transmission destination into the external storage medium.

6. The image transmission apparatus according to claim 1, wherein the transmission destination information includes a facsimile number, an electronic mail address, or an address of an FTP server.

7. The image transmission apparatus according to claim 6, further comprising a storage that stores, when the transmission destination is accepted based on the transmission destination information read from the external storage medium, historical information of a transmission performed to the accepted transmission destination into the external storage medium.

8. The image transmission apparatus according to claim 1, further comprising a storage that stores, when the transmission destination is accepted based on the transmission destination information read from the external storage medium, historical information of a transmission performed to the accepted transmission destination into the external storage medium.
